(19) United States
(12) Patent Application Publication
(10) Pub. No.: US 2002/0065574 A1
(43) Pub. Date: May 30, 2002

(54) Data processor, semiconductor integrated circuit and CPU

(76) Inventor: Kunihiro Nakada, Koganei (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 09/984,994

(22) Filed: Nov. 1, 2001

(30) Foreign Application Priority Data
Nov. 7, 2000 (JP) 2000-338807

(51) Int. Cl. G06F 19/00; G06F 7/48

(52) U.S. Cl. 700/121; 708/190; 700/117

(57) ABSTRACT

A data processor has a multiple length arithmetic circuit set with control data by a CPU that decodes and executes instructions through a bus, which performs processing for multiple length data based on the set control data. The multiple length arithmetic circuit performs a multiple length data operation by repeating processing where it makes read access to multiple length data at every unit of processing for multiple bits, partially operates read data, makes write access to the partially operated result, and delivers arithmetic information needed for the next partial operation to the next partial operation. The multiple length arithmetic circuit is a bus master module performing addressing operations by itself. It only operates by receiving control data setting from the CPU. The CPU does not need to repeatedly execute data transfer and add-subtract instructions. Multiple length data operations required for the Elliptic Curve Cryptosystem can be executed faster.

### BACKGROUND OF THE INVENTION

The present invention relates to a data processor and a CPU (central processing unit) best suited for the operation of the Elliptic Curve Cryptosystem and a semiconductor integrated circuit for digital signal processing, which relates to an effective technique adapted to IC cards, for example.

In the sophisticated information society, there is an urgent need to ensure high security for information that is exchanged through media such as networks and IC cards in terms of the protections of privacy and copyright and the security for property. A variety of cryptographic techniques have been proposed. For cryptographic processing, there is RSA (Rivest Shamir Adleman), one of public key cryptosystems, which is widely used as a standard of the public key cryptography. However, in order to decrypt the RSA cryptography, a huge integer needs to be factorized into prime factors. Additionally, a secret key cryptographic algorism, which is called the DES (Data Encryption Standard), has also been proposed. When a cryptographic algorithm is implemented by a microcomputer in the IC cards, there is an increasing need for mounting functions of executing cryptographic processings such as the RSA and the DES at high speed in view of speeding up encryption and decryption processing. In these cryptographic processings, they often handle multiple length (multiple times that exceeds several times as much as bits for a unit of data processing such as words) numeric values such as 512 bits and 1024 bits for harder decryption. For responding to the needs, dedicated arithmetic processing for residue multiplication, which is needed in the cryptographic processing such as the RSA and the DES, can be executed by incorporating a coprocessor into a microcomputer.

Furthermore, as a next generation cryptosystem, there is the Elliptic Curve Cryptosystem. This is a public-key cryptosystem that performs encryption and decryption based on a special addition defined by an equation called an elliptic curve. The difficulty of decryption is considered to be the same as solving discrete logarithm problems on an elliptic curve, which can ensure high security with a short key.

Moreover, Japanese Patent Laid-Open No. 143688/1999 describes an elliptic cryptography arithmetic apparatus intended for reducing a circuit scale and shortening arithmetic processing time.

### SUMMARY OF THE INVENTION

In the Elliptic Curve Cryptosystem, the addition, subtraction, increment and decrement of multiple length numeric values need to be performed at high speed. Current coprocessors do not respond to the need. The inventor found that they take time to perform processing and poorly perform encryption when these processings are implemented in instruction execution processing where data transfer or add-subtract instructions of a CPU are repeatedly run many times. Japanese Patent Laid-Open No. 143688/1999 does not take into consideration on this point, which allows both operations, the RSA cryptosystem operation and the elliptic curve cryptosystem operation by adding an add-subtract circuit and a reciprocal arithmetic circuit to a residue multiplying circuit and intends to realize a size reduction in a circuit scale by using a working memory instead of a data register.

The purpose of the invention is to provide a data processor or CPU capable of executing arithmetic operations such as addition, subtraction, increment and decrement of multiple length numeric values and logical operations at high speed.

Another purpose of the invention is to provide a data processor, a CPU and a semiconductor integrated circuit capable of speeding up multiple length arithmetic required for the Elliptic Curve Cryptosystem.

The aforesaid and other purposes of the invention will be apparent from the description and accompanying drawings of the specification.

The brief summary of representative inventions among the inventions disclosed in the application is as follows.

[1] In view of a data processor such as a microcomputer, a data processor (1) includes a CPU (2) for decoding and executing instructions and a multiple length arithmetic circuit (8) set with control data by the CPU through a bus (13) for performing processing for multiple length data based on the set control data in one semiconductor chip. The multiple length arithmetic circuit performs a multiple length data operation by repeating processing in which it makes read access to multiple length data at every unit of processing for multiple bits, partially operates read data, makes write access to the partially operated result and delivers arithmetic information needed for the next partial operation to the next partial operation. Here, the multiple length arithmetic circuit is positioned as an arithmetic module such as an accelerator for the CPU. The multiple length arithmetic circuit is a bus master module that performs addressing operations by itself; it only operates by receiving control data setting from the CPU. TheCPU does not need to repeatedly execute data transfer instructions, add-subtract instructions and increment/decrement instructions. Thereby, the addition, subtraction, increment and decrement of multiple length numeric values needed for the Elliptic Curve Cryptosystem can be executed at high speed. Furthermore, multiple length arithmetic operations and logical operations for other purposes can also be executed at high speed.

As a specific embodiment of the invention, the multiple length arithmetic circuit (8) has a control register (21) where the CPU sets the control data. Additionally, the multiple length arithmetic circuit has an operation control part (20) for decoding an operation control code (EXCRD) included in the control data for operation control.

Furthermore, as a specific embodiment of the invention, the multiple length arithmetic circuit (8) has an arithmetic and logic unit (24) where a carry signal of the most significant bit is allowed to feedback to the least significant bit through a latch circuit (33). The arithmetic and logic unit performs additions, subtractions, increments, decrements and further logical operations in accordance with the operation control code.

As a specific embodiment of the invention, the multiple length arithmetic circuit (8) may have an address arithmetic unit (22) for performing address arithmetic for the read access and write access. The control data holds initial address information (MADR) for the read access and write access. The address arithmetic unit sequentially updates the initial address information held by the control data and outputs access address information.

As a specific embodiment of the invention, the multiple length arithmetic circuit (8) has a counter (23) for counting the number of processings repeated at every unit of processing for the multiple bits. Aconfigurationinwhichthecompletion of processing for the multiple length data is detected by using counted values of the counter can be adopted.

As a specific embodiment of the invention, a bus arbiter (10) for arbitrating a bus use right between the CPU and the multiple length arithmetic circuit may be disposed when a RAM (4) is connected to the bus and the RAM is shared by the CPU and the multiple length arithmetic circuit through the bus.

As a specific embodiment of the invention, an IC card (70) may be configured by mounting the data processor (1) on a card substrate (71). According to the IC card, Elliptic Curve Cryptosystem processing can be executed at relatively high speed to realize security improvement on recorded information.

[2] In view of feature expansion for data storages such as a memory LSI or memory module, a semiconductor integrated circuit (1A) has buffer circuits (40,41), local buses (42,43) connected to the buffer circuits, and a multiple length arithmetic circuit (8A) and a memory part (15A) commonly connected to the local buses. The multiple length arithmetic circuit performs a multiple length data operation by repeating processing in which it is set with control data through the buffer circuits, makes read access to multiple length data in the memory part at every unit of processing for multiple bits based on the set control data, partially operates read data, makes write access to the partially operated result in the memory part and delivers arithmetic information needed for the next partial operation to the next partial operation. The multiple length arithmetic circuit performs addressing operations for data access on the local buses by itself and thus a CPU (2) does not need to repeatedly execute data transfer instructions or add-subtract instructions. Thereby, additions and subtractions of multiple length numeric values needed for the Elliptic Curve Cryptosystem can be executed at high speed. Particularly, the buffer circuits are controlled in a high impedance state when the multiple length arithmetic circuit performs multiple length arithmetic processing using the memory part. In the configuration of the semiconductor integrated circuit, the local busses are separable from CPU buses through the buffer circuits and controlling the buffer circuits in the high impedance state eliminates the bus right arbitration with the CPU even though the multiple length arithmetic circuit performs multiple length arithmetic using data in the memory part.

As a specific embodiment of the invention, the multiple length arithmetic circuit (8A) has a control register (21) where the control data is allowed to make write access from outside through the buffer circuits. Additionally, the multiple length arithmetic circuit may have an operation control part (20) for decoding an operation control code included in the control data for operation control.

As a specific embodiment of the invention, the multiple length arithmetic circuit (8A) may have an arithmetic and logic unit (24) where the control part controls its operation and a carry signal of the most significant bit is allowed to feedback to the least significant bit through a latch circuit (33).

As a specific embodiment of the invention, the multiple length arithmetic circuit (8A) has an address arithmetic unit (22) for performing address arithmetic for the read access and write access. The control data holds initial address information (MADR) for the read access and write access. The address arithmetic unit sequentially updates the initial address information held by the control data and outputs access address information.

As a specific embodiment of the invention, the multiple length arithmetic circuit (8A) has a counter (3) for counting the number of repeated processings at every unit of processing for the multiple bits. A configuration in which the completion of processing for the multiple length data is detected by using the counted values of the counter can be adopted. [3] A viewpoint in which a multiple length arithmetic instruction is included in an instruction set of the CPU is focused. A CPU (2A) includes an instruction register (54), an instruction decoder (53) for decoding instructions held in the instruction register to generate control signals, and an execution part (50,51,52) for executing operations based on the control signals outputted from the instruction decoder, which can execute data transfer instructions, multiple length arithmetic instructions and other operation instructions by using them. Here, the multiple length arithmetic instruction has a single operation code (OP) that specifies a multiple length data operation repeating processing where multiple length data is made read access at every unit of processing for multiple bits, read data is partially operated, the partially operated result is made write access, and arithmetic information required for the next partial operation is delivered to the next partial operation. In short, the processing specified by the multiple length arithmetic instruction is attained at the number of clock cycles smaller than the case where the data transfer instructions and the other operation instructions are repeatedly executed at every unit of data processing for multiple bits for substitution. Accordingly, when the multiple length processing instruction is executed, the CPU 2A can execute add-subtract processing for multiple length numeric values needed for the Elliptic Curve Cryptosystem at high speed as compared with the case of repeatedly executing data transfer instructions or add-subtract instructions.

As a specific embodiment of the invention, the multiple length arithmetic instruction includes, for example, initial address information (MADR) for the read access and write access and word count data (WRD) that indicates the number of processings repeated at every unit of processing for the multiple bits, in addition to the operation code.

As a specific embodiment of the invention, the execution part has an arithmetic and logic unit (64) where a carry signal of the most significant bit is allowed to feedback to the least significant bit through a latch circuit.

As a specific embodiment of the invention, the execution part has an address arithmetic unit (62) for performing address arithmetic for the read access and write access.

As a specific embodiment of the invention, the execution part has a counter (63) for counting the number of processings repeated at every unit of processing for the multiple bits and the completion of processing for the multiple length data is detected by using the counted values of the counter.

As a specific embodiment of the invention, an IC card (70) may be configured by mounting the CPU (2A) on a card substrate (71). According to the IC card, Elliptic Curve Cryptosystem processing is performed at relatively high speed to realize security improvement on recorded information.

### BRIEF DESCRIPTION OF THE DRAWINGS

The teachings of the invention can be readily understood by considering the following detailed description in conjunction with the accompanying drawings, in which:

FIG. 1 depicts a block diagram illustrating one example of a data processor in the invention:

FIG. 2 depicts a block diagram illustrating one example of a multiple length arithmetic circuit;

FIG. 3 depicts a block diagram illustrating one example of a 16-bit ALU included in the multiple length arithmetic circuit;

FIG. 4 depicts an operating timing chart of an increment operation for multiple length data;

FIG. 5 depicts an operating timing chart of an add operation for multiple length data;

FIG. 6 depicts an illustration exemplifying instruction streams and clocks in the case where an add operation of multiple length data is executed by software processing by a CPU as a comparative example;

FIG. 7 depicts a block diagram illustrating one example of a semiconductor integrated circuit where a multiple length arithmetic circuit is disposed with a memory unit in one piece;

FIG. 8 depicts a block diagram exemplifying a CPU where a multiple length arithmetic instruction is included in an instruction set;

FIG. 9 depicts a format diagram exemplifying an instruction format of the multiple length arithmetic instruction;

FIG. 10 depicts a plan view exemplifying an appearance of an IC card mounted with a data processor;

FIG. 11 depicts an illustration exemplifying an overview of the utilization of IC cards in an electronic money system; and

FIG. 12 depicts an illustration exemplifying the utilization of IC cards in GSM mobile telephones.

### DESCRIPTION OF THE PREFERRED EMBODIMENTS

<Accelerator for a CPU>

First, a specific example of a multiple length arithmetic circuit focused as an accelerator or bus master module for a CPU will be described.

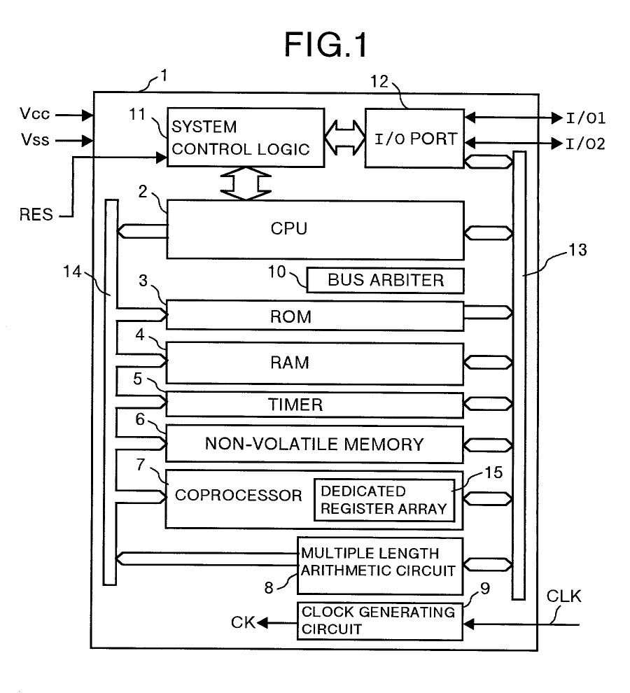

FIG. 1 depicts one example of a data processor in the invention. A data processor 1 shown in the same drawing is not defined specifically, but it is a microcomputer that is a so-called IC card microcomputer. The data processor 1 shown in the same drawing is fabricated by a semiconductor integrated circuit fabrication technique of one semiconductor substrate or semiconductor chip such as a monocrystal silicon with a CMOS device.

The data processor 1 has a CPU 2, a ROM 3, a RAM 4, a timer 5, a non-volatile memory 6, a coprocessor 7, a multiple length arithmetic circuit 8, a clock generating circuit 9, a bus arbiter 10, a system control logic 11, an input/output port (I/O port) 12, a data bus 13 and an address bus 14.

The ROM 3 has an operating program and a data table for the CPU 2. The RAM 4 is regarded as a work region for the CPU 2 or a temporary storage region for data, which is comprised of an SRAM (static random access memory) or DRAM (dynamic random access memory). The CPU 2 fetches instructions from the ROM 3, decodes the fetched instructions and performs operand fetches or data operations based on the decoded result. The coprocessor 7 is regarded as a processor unit that performs residue multiplication processing in the RSA or Elliptic Curve Cryptosystem operation instead of the CPU 2, which has a dedicated register array 15 configured of an SRAM inside thereof. The I/O port has 2-bit input/output terminals I/O 1 and I/O 2, which are shared for inputting and outputting data and inputting external interrupting signals. The I/O port 12 is connected to the data bus 13. The data bus is connected to the CPU 2, the ROM 3, the RAM 4, the timer 5, the non-volatile memory 6, the coprocessor 7 and the multiple length arithmetic circuit 8. In the data processor 1, the CPU 2 and the multiple length arithmetic circuit 8 are regarded as bus master modules, which are allowed to output address signals to the address bus 14 connected to the ROM 3, the RAM 4, the timer 5, the non-volatile memory 6 and the coprocessor 7. The bus arbiter 10 conducts the bus right arbitration between the CPU 2 and the multiple length arithmetic circuit 8. The system control logic 11 conducts operation mode control and interrupt control for the data processor 1, which further has random number generation logic utilized in creating a cryptographic key. RES is a reset signal for the data processor 1. When the data processor 1 is instructed to do reset operation by the reset signal RES, the inside thereof is initialized and the CPU 2 starts to execute an instruction from the top address of a program in the ROM 3. The clock generating circuit 9 receives an external clock signal CLK to generate an internal clock signal CK. The data processor 1 is synchronously operated to the internal clock signal CK.

The non-volatile memory 6 is not defined specifically, but it is comprised of an electrically rewritable flash memory, which is used as a storage region for various data. For example, stored data of the non-volatile memory 6 is encrypted. Encryption and decryption processing is performed by using the coprocessor 7 or the multiple length arithmetic circuit 8. The Elliptic Curve Cryptosystem, for example, is adopted for the encryption and decryption logic.

Not defined particularly, the CPU 2 is a so-called 16-bit CPU, which is allowed to perform processing at a 16-bit (word) unit, and has a 16-bit general purpose register and a 16-bit arithmetic and logic unit, not shown. The data bus 13 is regarded as 16 bits. Accordingly, almost all the data transfer instruction or operation instruction included in the instruction set of the CPU 2 can process data at a 16-bit unit. However, not limited particularly, as for operations with a carry, data to be operated is defined to an 8-bit unit.

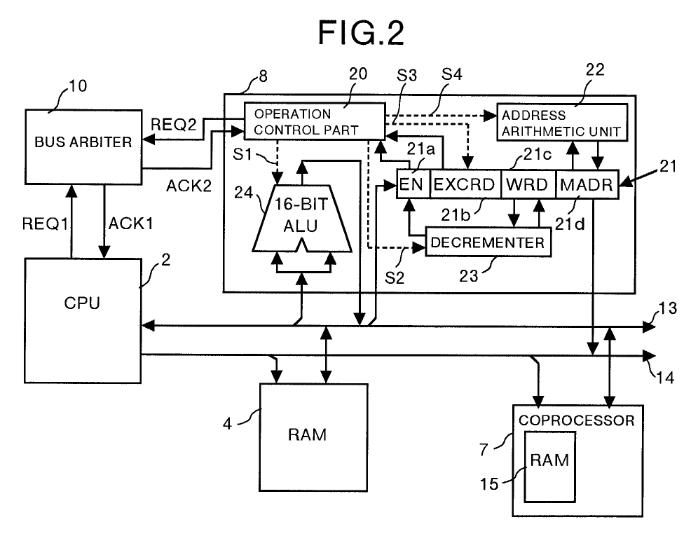

FIG. 2 depicts one example of the multiple length arithmetic circuit 8. The multiple length arithmetic circuit 8 has an operation control part 20, a control register 21, an address arithmetic unit 22, a decrementer 23 and an arithmetic and logical unit (16-bit ALU) 24.

The CPU 2 initializes the control register 21 with control data through the data bus 13. The CPU 2 executes a data transfer instruction for the initialization. As shown in FIG. 2, the control data has an operation enable bit EN, an operation control code EXCRD, an initial address information MADR and a word count specifying information WRD for specifying data word counts for multiple length data; each information is stored in predetermined fields 21a to 21d in the control register 21. Here, a unit of processing at every multiple bit for the multiple length data is set to 16 bits being a bus width (bit counts) of the data bus 13. This unit of processing is determined in accordance with a CPU configuration and a data bus width, which may be 32 bits. The multiple length data has a unit of data predetermined multiple times greater than the fundamental unit of bits, for example, 16×64=1024 bits.

Not defined specifically, the operation control code EXCRD is regarded as code information of multiple bits for specifying arithmetic operations such as increment (INC), decrement (DEC), addition (ADD) and subtraction (SUB) and logical operations such as exclusive OR (EOR). The operation control part 20 starts control operation responding to the operation enable bit EN being set to logical value “1” by the CPU 2. The operation control part 20 decodes the operation control code EXCRD and controls the operation of the 16-bit ALU 24, the address arithmetic unit 22 and the decrementer 23 according to the decoded result.

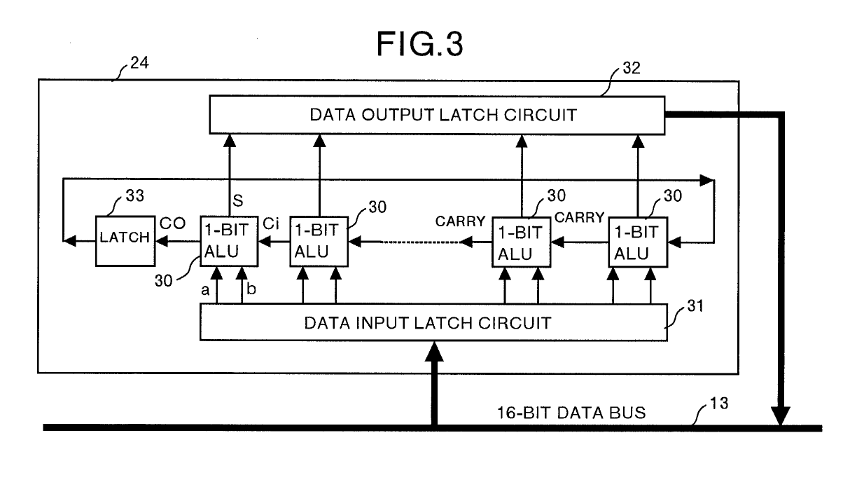

As shown in FIG. 3, 16 of 1-bit ALUs (full adders) 30 are serially connected in the 16-bit ALU 24. The full adder 30 has two data input terminals a and b, a data output terminal s, a carry-in terminal ci from the lower side and a carry-out terminal co to the higher side. Each of the data input terminals a and b of the full adders 30 is connected to outputs of a 16-bit data input latch circuit 31. The data output terminals s of the full adders 30 are connected to input terminals of a 16-bit data output latch circuit 32. The data input latch circuit 31 inputs data from the data bus 13 and the data output latch circuit 32 is allowed to output data to the data bus 13. A carry signal is sequentially transferred fromthe least significant full adder 30 to themost significant full adder 30. The carry signal of the most significant full adder 30 is latched in a carry latch circuit 33 and is allowed to feedback to the carry-in terminal of the least significant full adder 30. The carry latch circuit 33 has a function of holding the carry signal until the next data is latch-complete in the data input latch circuit 31 in repeating operations of the 16-bit unit.

The address arithmetic unit 22, for example, sequentially increments (or decrements) and updates the initial address information MADR for the operation control data on the field 21a of the control register 21. The operation control unit 20 performs data addressing by using address information held by the field 21b of the control register 21 as a data read access address and a data write access address for multiple length arithmetic.

The decrementer 23 sequentially decrements the word count specifying information WRD for operation control data on the filed 21c of the control register 21. When the decremented result is turned to be numeric value 0, the operation enable bit EN is turned to be logical value “0”. Thereby, the operation control part 20 recognizes the completion of the multiple length arithmetic instructed by the operation control data.

The multiple length arithmetic circuit 8 has an addressing function for the RAM 4, as described above. In this sense, it is positioned as a bus master module as similar to the CPU sharing the address bus 14 and the data bus 13. The bus arbiter 10 arbitrates the right to use the address bus 14 and the data bus 13 between the CPU 2 and the multiple length arithmetic circuit 8. In FIG. 2, the bus right arbitration is performed by handshake control according to request signals REQ1 and REQ2 and acknowledge signals ACK1 and ACK2. That is, the CPU 2 and the multiple length arithmetic circuit 8 assert the request signals REQI and REQ2 to the bus arbiter 10 when they require bus access, and they negate the request signals REQI and REQ2 when they relinquish the bus right. The bus arbiter 10 acknowledges the bus right by asserting the corresponding acknowledge signals ACK1 and ACK2 responding to the assert states of the request signals REQI and REQ2, but it acknowledges the bus right by giving priority to the request of earlier assert timing when the assert states of the request signals REQ1 and REQ2 compete.

Next, the operation of the multiple length arithmetic circuit 8 will be described. The CPU 2 sets a kind of arithmetic, word counts (64 words, for example) and an initial value of a memory address that performs arithmetic to the control register 21. For example, when the kind of arithmetic is increment,read data is incremented by 1 and is written. Thus, the initial value of the memory address is regarded as two kinds, initial read and write addresses. When the kind of arithmetic is addition, a first read data is added with a second read data and the added result is written. Therefore, the initial value of the memory address is regarded as three kinds, first and second read addresses and an initial write address. Generally, the write address is matched to the second read address and thus the address initial value may be two kinds.

When the CPU 2 sets the operation enable bit EN in the control register to logic value “1”, the CPU 2 negates the request signal REQ1 to open the bus right. The multiple length arithmetic circuit 8 responds to the logic value “1” of the operation enable bit EN, asserts the request signal REQ2 to demand the bus right and attains the bus right in accordance with the bus arbiter 10 returning the acknowledge signal ACK2.

The multiple length arithmetic circuit 8 controls multiple length arithmetic specified by the operation control code EXCRD. That is, control signals S1 to S4 obtained by decoding the operation control code EXCRD control the 16-bit ALU 24, the decrementer 23, the control register 21 and the address arithmetic unit 22.

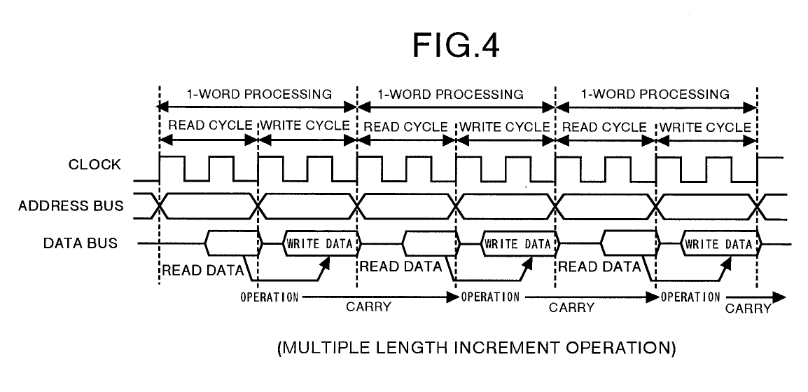

For example, in the case of a multiple length increment operation exemplified in the operating timing shown in FIG. 4, data read, increment for the read data and data write are performed at a word unit from the least significant word of the multiple length data on the RAM 4 specified by the initial address information MADR and a carry that is generated as a result of the increment is transferred to the next word operation. The processing at every word is continuously, repeatedly executed until the specified word counts are complete. The value of the word count specifying information WRD is decremented on the field 21c every time when the processing at every word is complete. Thus, when this value is turned to be zero, processing for the required word counts, in other words, the completion of arithmetic processing for one piece of multiple length data specified by the operation control data is recognized.

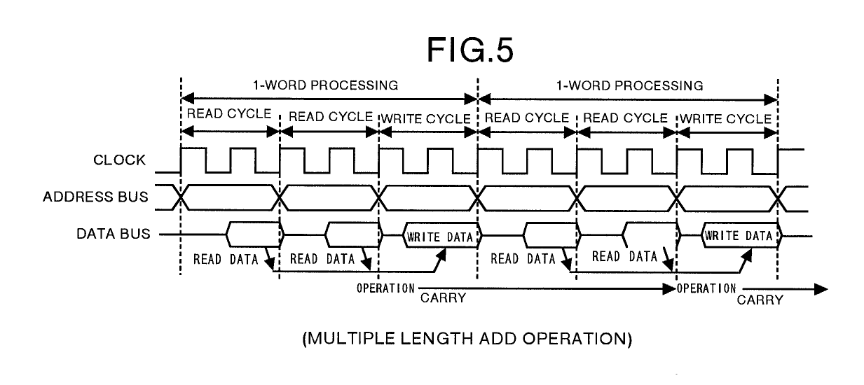

For example, in the case of multiple length add operation exemplified in the operating timing shown in FIG. 5, first and second data reads, addition to first and second read data and added data writes are performed at a word unit from the respective least significant words of first and second multiple length data on the RAM 4 specified by the initial address information MADR and a carry that is generated as a result of the add operation is transferred to the next word operation. The processing at every word is continuously, repeatedly executed until the specified word counts are complete.

For example, when a multiple length data operation of 1024 bits is executed using the data bus 13 of a 16-bit width, arithmetic processing is executed 64 times. Therefore, the operation is complete at 4 clocks×64 times=256 clock cycles in the increment processing shown in FIG. 4, 6 clocks×64 times=384 clock cycles in the add processing shown in FIG. 5. Additionally, one memory cycle is set to two clock cycles here, but one memory cycle can be set to one clock cycle when a high-speed memory is used. Inversely, one memory cycle may be set to one clock cycle by reducing clock frequencies.

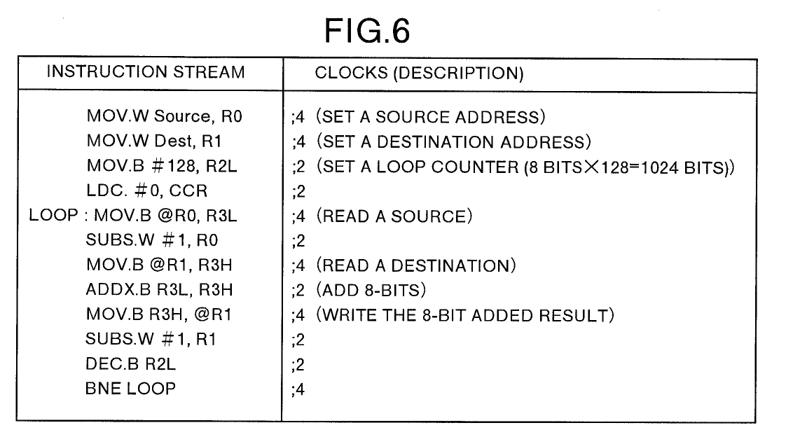

As a comparative example, instruction steams and clocks in the case of executing a multiple length add operation by software processing by the CPU 2 are shown in FIG. 6. In the software processing here, an add instruction (ADDX) with a carry where a unit of data processing is defined to 8 bits, a subtract instruction (SUBS) and data transfer instructions (MOV) are used. In the arithmetic processing in the comparative example, a register RO is initialized with a source address, a register RI1 is initialized with a destination address, and a loop counter R2L is set with 128. Then, enter a loop. Source data is read to a register R3L from the source address, the source address of the register RO is subtracted by one, destination data is read to a register R3H from the destination address, the values of the registers R3L and R3H are added, the added result is written on the source address of the register RO, the destination address of the register R1 is subtracted by one, the loop counter R2L is decremented by one; and the loop processing is repeated until the value of the loop counter R2L is turned to be zero. In the software processing by the CPU, many general instructions are fetched and executed. Thus, 3084 clock cycles are needed for add processing for the multiple length data of 1024 bits. Even though the CPU could execute add operations with a carry at a 16-bit unit, the number of the clock cycles for the software processing by the CPU is merely to be about half.

When execution clocks for the add processing shown in FIG. 5 using the multiple length arithmetic circuit 8 are compared with the 3084 clocks in the aforesaid software processing by the CPU, the former realizes about eight-times speeding up. Accordingly, the use of the multiple length arithmetic circuit 8 can drastically reduce processing time for the Elliptic Curve Cryptosystem which heavily uses multiple length add processing.

<Feature Expansion for Data Storages>

Next, a specific example of the multiple length arithmetic circuit will be described in view of feature expansion for data storages such as a RAM.

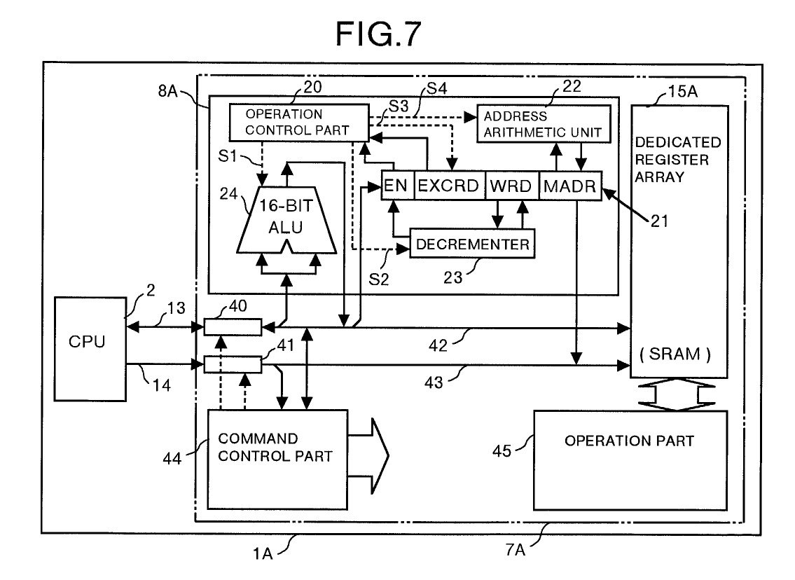

FIG. 7 depicts one example of a semiconductor integrated circuit 1A in the invention. Here, an example is shown that a multiple length arithmetic circuit 8A is disposed near a dedicated register array 15A comprised of an SRAM incorporated into a coprocessor 7A. The semiconductor integrated circuit 1A shown in FIG. 7 is not defined specifically, but it corresponds to the configuration where the multiple length arithmetic circuit 8 is incorporated into the coprocessor 7 in the data processor 1 shown in FIG. 1.

The coprocessor 7A is connected to a data bus 13 and an address bus 14 through a data input/output buffer circuit 40 and an address input buffer circuit 41. Inside the coprocessor 7A, the data input/output buffer circuit 40 is connected to a local data bus 42 and the address input buffer circuit 41 is connected to a local address bus 43. These local buses 42 and 43 are commonly connected to the multiple length arithmetic circuit 8A and the dedicated register array (memory part) 15A. In addition to this, the local data buses 42 and 43 are connected to a command control part 44, and the dedicated register array 15A is connected to an operation part 45 such as a product-sum operation unit, which is a basic coprocessor. The configuration of the multiple length arithmetic circuit 8A is almost the same as that shown in FIG. 1, but it is different in that an operation control part 20A does not have the function of controlling the bus request and the bus acknowledge. The multiple length arithmetic circuit 8A does not output bus request signals or input bus acknowledge signals.

The buffer circuits 40 and 41, the multiple length arithmetic circuit 8A, the dedicated register array 15A and the operation part 45 are controlled by the command control part 44. A CPU 2 creates a command from a coprocessor instruction to give it to the command control part 44 when the fetched instruction includes the coprocessor instruction. The command control part 44 decodes the command and allows the operation part 45 to execute a product-sum operation or alternatively allows the multiple length arithmetic circuit 8A to execute a multiple length arithmetic. When the multiple length arithmetic is executed, the command control part 44 sets control data to the control register 21 and sets an operation enable bit EN to logic value “1”. Thereby, multiple length arithmetic is started. At this time, a local address of the dedicated register array 15A is set to a memory address and the multiple length arithmetic is performed using data of the dedicated register array 15A. The detail of the multiple length arithmetic is the same as that described before. However, when the multiple length arithmetic circuit 8A performs the multiple length arithmetic, the command control part 44 controls the data input/output buffer circuit 40 and the address input buffer circuit 41 in the high impedance state so that the states of the local buses 42 and 43 do not influence external buses 13 and 14.

The multiple length arithmetic circuit 8A itself performs addressing operation for data access on the local buses 42 and 43 and thus the CPU 2 does not need to repeatedly execute data transfer instructions or add-subtract instructions for multiple length arithmetic. Thereby, the add-subtract operation of multiple length numeric values needed for the Elliptic Curve Cryptosystem can be executed at high speed. Particularly, the buffer circuits 40 and 41 are controlled in the high impedance state when the multiple length arithmetic circuit 8A performs multiple length arithmetic processing using the dedicated register array 15A. In the configuration of this semiconductor integrated circuit, the local buses 42 and 43 are separatable from the CPU buses 13 and 14 through the buffer circuits 40 and 41. Even though the multiple length arithmetic circuit 8A performs multiple length arithmetic using data of the dedicated register array 15A, the bus right arbitration with the CPU 2 is unnecessary because the buffer circuits 40 and 41 are controlled in the high impedance state.

<Support for Multiple Length Arithmetic Instruction>

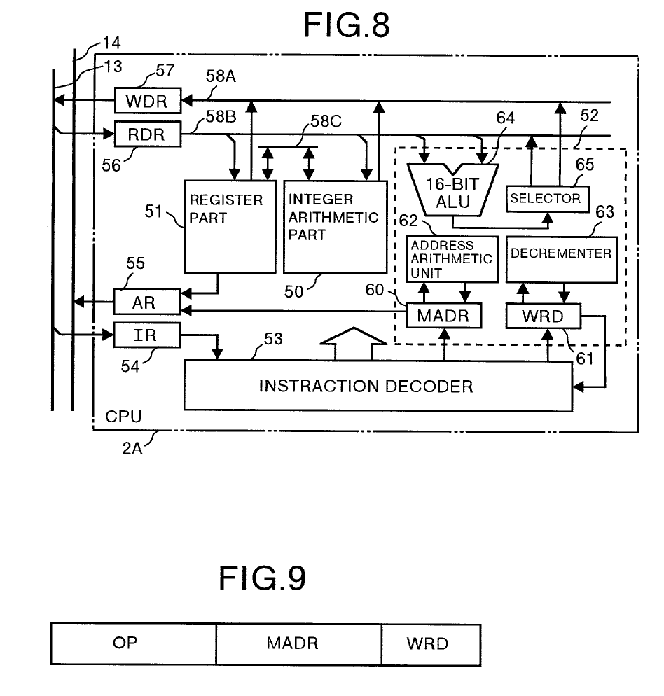

Next, a CPU including a multiple length arithmetic instruction in the instruction set will be described. A CPU 2A shown in FIG. 8 has an integer arithmetic part 50, a register part 51, a multiple length arithmetic part 52, an instruction decoder 53, an instruction register (IR) 54, an address output register (AR) 55, a read data register (RDR) 56, a write data register (WDR) 57 and internal buses 58A to 58C.

The internal buses 58A to 58C are 16 bits. The register part 51 has a 16-bit general purpose register, a program counter and a condition code register. The address output register 55 outputs an instruction address for instruction fetch or operand address for operand access to an address bus 14. The integer arithmetic part 50 is configured to have an arithmetic and logic unit or shifter. The instruction read by the instruction address is fetched by the instruction register 54, the fetched instruction is decoded by the instruction decoder 53 or required information is cut out of the instructions. They are used for operation control for the register part 51, the integer arithmetic part 52 and the multiple length arithmetic part 52, whereby the CPU 2A executes instructions. The register part 51, the integer arithmetic part 50 and the multiple length arithmetic part 52 configure an execution part for instructions.

The instruction set of the CPU 2A includes a data transfer instruction, an operation instruction, a branch instruction and a control instruction. The operation instruction has instructions for multiple length arithmetic operations such as addition, subtraction, increment and decrement utilizing the multiple length arithmetic part 52 and multiple length logical operations such as exclusive OR utilizing the multiple length arithmetic part 52, and instructions for arithmetic operations such as addition, subtraction, increment and decrement and logical operations such as exclusive OR utilizing the integer arithmetic part 50. Here, the multiple length arithmetic instruction has a single operation code that specifies multiple length data operation repeating processing where multiple length data is made read access at every unit of processing for multiple bits, the read data is partially operated, the partially operated result is made write access, and arithmetic information needed for the next partial operation is delivered to the next partial operation. In short, the processing specified by the multiple length arithmetic instruction is attained at clock cycles smaller than the case where the data transfer instructions and other operation instructions are repeatedly executed at every unit of data processing for multiple bits for substitution using the integer arithmetic part 50. Accordingly, when the multiple length arithmetic instruction is executed, the CPU 2A can execute add-subtract processing for multiple length numeric values needed for the Elliptic Curve Cryptosystem at high speed as compared with the case where the integer arithmetic part 50 repeatedly executes data transfer instructions or add-subtract instructions.

Here, an instruction format of the multiple length arithmetic instruction will be described. For example, as shown in FIG. 9, the multiple length arithmetic instruction includes the operation code OP for specifying kinds of arithmetic, the initial address information MADR for read access and write access and the word count data WRD for indicating the number of processings repeated at every unit of processing for multiple bits. For example, when a multiple length increment operation instruction is expressed in mnemonic, it can be expressed in “INC. LW# MEMORY ADDRESS, # WORD COUNTS”. LW means a long word such as 1024 bits length. # MEMORY ADDRESS means the initial address information MARD, and # WORD COUNTS means the word count data WRD.

The multiple length arithmetic part 52 has control registers 60 and 61, an address arithmetic unit 62, a decrementer 63, a 16-bit ALU 64 and a selector 65. The 16-bit ALU 64 has the same configuration as that shown in FIG. 3. The selector 65 selects output to the internal bus 58B when the output of the 16-bit ALU 64 is fed back to input, and selects output to the internal bus 58A when the output of the 16-bit ALU 64 is written outside the CPU. When the instruction decoder 53 decodes the operation code OP of the multiple length arithmetic instruction, it sets the initial address information MADR included in the instruction to the control register 60 and the word count data WRD included in the instruction to the control register 61 and outputs various control signals corresponding to multiple length arithmetic processing specified by the operation code OP.

The address arithmetic unit 62, for example, sequentially increments and updates the initial address information MADR on the control register 60. The instruction decoder 53 turns address information held by the control register 60 to be data read access addresses and data write access addresses for multiple length arithmetic and outputs them outside through the address output register 55 at timing of performing data read or data write.

The decremetner 63 sequentially decrements the word count data WRD initialized in the control register 61. When the decremented result is set to numeric value zero, the instruction decoder 53 detects this and thereby recognizes the completion of the multiple length arithmetic specified by the multiple length arithmetic instruction.

The multiple length arithmetic operation using the multiple length arithmetic part by the CPU2A is basically the same as the operation by the multiple length arithmetic circuit 8 shown in FIG. 2. The difference is in that the CPU 2A itself creates the required control information by decoding the multiple length arithmetic instruction by the instruction decoder 53, whereas the CPU 2 initialized the operation control information to the control register 21 in FIG. 2. Accordingly, a program specifies kinds of arithmetic, word counts (64 words, for example) and memory addresses for arithmetic. Operating timing is the same as that shown in FIGS. 4 and 5. In the case of the multiple length increment operation instruction, data read, increment for the read data and the incremented data write are performed at every word unit from the least significant word of multiple length data on the memory specified by the initial address information MADR and a carry that is generated as a result of the increment is transferred to the next word operation. The processing at every word is continuously, repeatedly executed until the specified word counts are complete. The value of the word count data WRD is decremented everytimewhentheprocessingateverywordiscomplete. Thus, processing for the required word counts, that is, arithmetic processing for one multiple length data is complete when the value is turned to be zero.

The multiple length arithmetic instruction is included in the instruction set of the CPU 2A. Thereby, control data does not need to be set to the control register by data transfer instructions and setting overhead can be reduced. Furthermore, the multiple length arithmetic part 52 is formed to be a part of the functions of the CPU 2A and thereby external bus right control can be facilitated. Moreover, the ease of use is provided for users.

The CPU 2A is mounted instead of the CPU 2 of FIG. 1 or the multiple length arithmetic circuit 8 and thereby a data processor or microcomputer can be configured.

<IC Card>

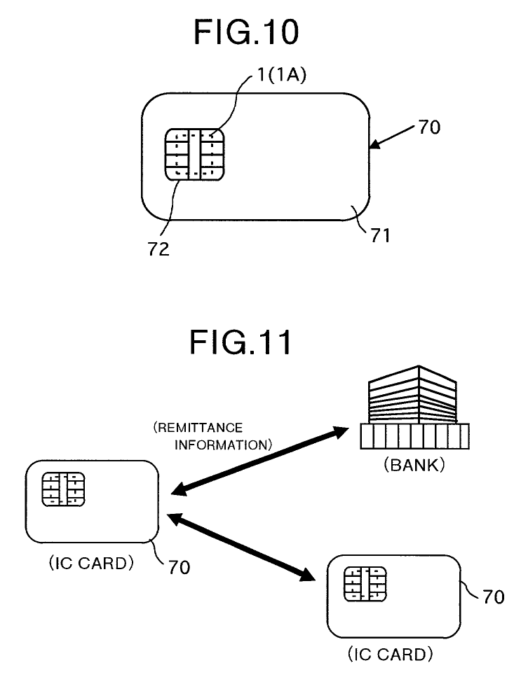

FIG. 10 depicts an appearance of an IC card 70 mounted with the data processor 1 of FIG. 1(a data processor mounted with the semiconductor integrated circuit 1A shown in FIG. 7 and the CPU 2A shown in FIG. 8). The surface of a cord substrate 71 made of plastic is formed with an electrode pattern 72, not defined specifically. The data processor 1 is mounted on the back surface of the card substrate 71. The electrode pattern 72 is connected to a corresponding external terminal of the data processor 1. According to the IC card 70, the Elliptic Curve Cryptosystem is performed at relatively high speed to realize security improvement on recorded information.

FIG. 11 depicts an overview of the utilization of the IC card in an electronic money system. As shown in FIG. 11, when the IC card 70 is used in the electronic money system, an amount of money or password is encrypted and stored in the non-volatile memory 6. The password or amount of money is decrypted when electronic money is used. Using the decrypted informationdetermines valid useor not. The necessaryamount of money is remitted to a bank or a predetermined amount of money is transferred to another IC card.

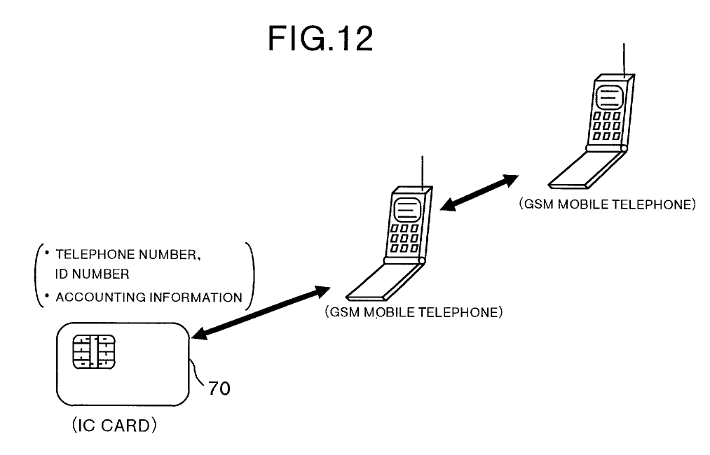

FIG. 12 depicts the utilization of the IC card in a GSM (Global System for Mobile Communications) mobile telephone. As shown in FIG. 12, when the IC card 70 is mounted on the GSM mobile telephone for use, user's telephone number, ID number and accounting information are encrypted and stored in the non-volatile memory 6. When using the phone, the information is decrypted, the use of the decrypted information determines valid use or not, accounting information is updated according to frequencies of use and again encrypted.

As described above, the invention made by the inventor has been described specifically in accordance with the embodiments, but the invention is not limited to them. It is not needles to say that it can be modified within the scope of teachings, not deviating it.

For example, a right-hand side circuit module mounted on the data processor is not limited to that shown in FIG. 1. A floating point arithmetic unit may be mounted. A Galois arithmetic circuit may be mounted as an accelerator for error correction. The non-volatile memory is not limited to the flash memory, which may be an EEPROM or dielectric memory. Additionally, the semiconductor integrated circuit having the multiple length arithmetic part with the memory part in one piece is not limited to the coprocessor, which may be other arithmetic units such as a single memory module and a floating point unit. Furthermore, multiple length arithmetic can of course be utilized for other purposes other than the Elliptic Curve Cryptosystem, which can be applied to multiple length logical operations, not only to arithmetic operations.

In the description mentioned above, the invention made by the inventor has been described mainly in the case of the cryptographic processor that is the background field of utilization, further in the case of applying it to the IC card. However, the data processor, the semiconductor integrated circuit and the CPU in the invention can be applied widely to various mobile devices themselves requiring multiple length arithmetic for encryption and decryption.

The following is a brief description of effects obtained by the representative inventions among the inventions disclosed in the application.

That is, the data processor, the CPU and the semiconductor integrated circuit capable of executing arithmetic operations such as addition, subtraction, increment, decrement of multiple length numeric values or logical operations at high speed can be realized.

Additionally, the data processor, the CPU and the semiconductor integrated circuit capable of speeding up multiple length arithmetic needed for the Elliptic Curve Cryptosystem can be provided.

Furthermore, according to the IC card applied to the data processor or CPU, Elliptic Curve Cryptosystem processing is performed at relatively high speed to realize security improvement on recorded information.

What is claimed is:

1. A data processor formed on a semiconductor chip comprising:
a CPU for decoding and executing an instruction; and
a multiple length arithmetic circuit set with control data by the CPU through a bus for performing processing for multiple length data based on the set control data,
wherein the multiple length arithmetic circuit performs a multiple length data operation by repeating processing in which it makes read access to multiple length data at every unit of processing for multiple bits, partially operates read data, makes write access to a partially operated result and delivers arithmetic information needed for a next partial operation to the next partial operation.

2. The data processor according to claim 1, wherein the multiple length arithmetic circuit includes a control register set with the control data by the CPU.

3. The data processor according to claim 2 wherein, the multiple length arithmetic circuit includes an operation control part for decoding an operation control code included in the control data for operation control.

4. The data processor according to claim 2 wherein, the multiple length arithmetic circuit includes an arithmetic and logic unit where a carry signal of a most significant bit is allowed to feedback to a least significant bit through a latch circuit.

5. The data processor according to claim 2 wherein, the multiple length arithmetic circuit includes an address arithmetic unit for performing address arithmetic for the read access and write access, and the control data includes initial address information for the read access and write access,
wherein the address arithmetic unit sequentially updates the initial address information held by the control data to output access address information.

6. The data processor according to claim 2 wherein, the multiple length arithmetic circuit includes a counter for counting the number of processings repeated at every unit of processing for the multiple bits and completion of processing for the multiple length data is detected by using counted values of the counter.

7. The data processor according to claim 2 further comprising a RAM connected to the bus, the RAM being shared by the CPU and the multiple length arithmetic circuit through the bus, and a bus arbiter for arbitrating a bus use right between the CPU and the multiple length arithmetic circuit.

8. An IC card comprising a data processor formed on a semiconductor chip mounted on a card substrate,
wherein the data processor includes a CPU for decoding and executing an instruction and a multiple length arithmetic circuit set with control data by the CPU through a bus for performing processing for multiple length data based on the set control data,
wherein the multiple length arithmetic circuit performs a multiple length data operation by repeating processing in which it makes read access to multiple length data at every unit of processing for multiple bits, partially operates read data, makes write access to a partially operated result and delivers arithmetic information needed for a next partial operation to the next partial operation.

9. A semiconductor integrated circuit comprising buffer circuits, local buses connected to the buffer circuits, and a multiple length arithmetic circuit and a memory part commonly connected to the local buses,
wherein the multiple length arithmetic circuit performs a multiple length data operation by repeating processing in which it is set with control data through the buffer circuits, makes read access to multiple length data in the memory part at every unit of processing for multiple bits based on the set control data, partially operates read data, makes write access to a partially operated result in the memory part and delivers arithmetic information needed for a next partial operation to the next partial operation, and the buffer circuits are controlled in a high impedance state during multiple length data processing by the multiple length arithmetic circuit.

10. The semiconductor integrated circuit according to claim 9, wherein the multiple length arithmetic circuit includes a control register where the control data is write accessable from outside through the buffer circuits.

11. The semiconductor integrated circuit according to claim 10, wherein the multiple length arithmetic circuit includes an operation control part for decoding an operation control code included in the control data for operation control.

12. The semiconductor integrated circuit according to claim 10, wherein the multiple length arithmetic circuit includes an arithmetic and logic unit where a carry signal of a most significant bit is allowed to feedback to a least significant bit through a latch circuit.

13. The semiconductor integrated circuit according to claim 10, wherein the multiple length arithmetic circuit includes an address arithmetic unit for performing address arithmetic for the read access and write access, and the control data includes initial address information for the read access and write access,
wherein the address arithmetic unit sequentially updates the initial address information held by the control data to output access address information.

14. The semiconductor integrated circuit according to claim 10, wherein the multiple length arithmetic circuit includes a counter for counting the number of processings repeated at every unit of processing for the multiple bits and completion of processing for the multiple length data is detected by using counted values of the counter.

15. A CPU capable of executing a data transfer instruction, a multiple length arithmetic instruction and other operation instructions comprising:
an instruction register;
an instruction decoder for decoding instructions held by the instruction register to generate control signals; and
an execution p art for performing opera tion based on the control signal ou tputted from the instruction decoder,
wherein the multiple length arithmetic instruction includes a single operation code that specifies a multiple length data operation repeating processing where multiple length data is made read access at every unit of processing for multiple bits, read data is partially operated, a partially operated result is made write access, and arithmetic information required for a next partial operation is delivered to the next partial operation.

16. The CPU according to claim 15, wherein the processing specified by the multiple length arithmetic instruction is attained at the number of clock cycles smaller than a case of repeatedly executing the data transfer instruction and the other operation instructions at every unit of data processing for multiple bit for substitution.

17. The CPU according to claim 15, wherein the multiple length arithmetic instruction includes initial address inf ormation for the read access and write access and word count data for indicating the number of processings repeated at every unit of processing for the multiple bits in addition to the operation code.

18. The CPU according to claim 15, wherein the execution part includes an arithmetic and logic unit where a carry signal of a most significant bit is allowed to feedback to a least significant bit through a latch circuit.

19. The CPU according to claim 18, wherein the execution part includes an address arithmetic unit for performing address arithmetic for the read access and write access.

20. The CPU according to claim 18, wherein the execution part includes a counter for counting the number of processings repeated at unit of processing for the multiple bits and completion of processing for the multiple length data is detected by using counted values of the counter.

21. An IC card comprising a CPU mounted on a card substrate capable of executing a data transfer instruction, a multiple length arithmetic instruction and other operation instructions,
wherein the CPU includes an instruction register, an instruction decoder f or decoding instructions held by the instruction register to generate control signals, and an execution part for performing operation based on the control signal outputted from the instruction decoder, the CPU being capable of executing the data transfer instruction, the multiple length arithmetic instruction and the other instructions by using them,
wherein the multiple length arithmetic instruction includes a single operation code that specifies a multiple length data operation repeating processing where multiple length data is made read access at every unit of processing for multiple bits, read data is partially operated, a partially operated result is made write access, and arithmetic information required for a next partial operation is delivered to the next partial operation.
